(19) United States
(12) Patent Application Publication
(10) Pub. No.: US 2024/0356142 A1
(43) Pub. Date: Oct. 24, 2024

(54) ENERGY STORAGE FOR A MOTOR VEHICLE

(71) Applicant: AUDI AG, Ingolstadt (DE)

(72) Inventors: Christian NEUFELDT, Langenbrettach (DE); Thorsten KEIM, Heilbronn (DE); Sönke KÜHL, Dossenheim (DE); Thomas MILDE, Wüstenrot (DE)

(73) Assignee: AUDI AG, Ingolstadt (DE)

(21) Appl. No.: 18/609,398

(22) Filed: Mar. 19, 2024

(30) Foreign Application Priority Data
Apr. 20, 2023 (DE) 102023110009.2

(51) Int. Cl. H01M 50/264; B60K 1/04; H01M 50/249

(52) U.S. Cl. CPC H01M 50/264; B60K 1/04; H01M 50/249; B60K 2001/0438; H01M 2220/20

(57) ABSTRACT

An energy storage for a motor vehicle, including a housing on which a plurality of fastening positions are formed, at which a fastening receptacle is provided for a fastening element to be connected to a body component. At least some of the fastening positions, a first fastening receptacle and a second fastening receptacle positioned offset from the first are provided, the two fastening receptacles of the fastening positions are provided offset in a common direction.

### FIELD

The invention relates to an energy storage for a motor vehicle, comprising a housing on which a plurality of fastening positions are formed, at which a fastening receptacle is provided for a fastening element to be connected to a body component.

### BACKGROUND

Modern motor vehicles that are partially or fully electrically powered have an appropriately sized energy storage. Such an energy storage has a housing, which can also be designed like a frame, and in which multiple individual storage modules are accommodated. Such an energy storage is often referred to as a high-voltage battery. The energy storage is fixed on the body side using suitable fastening elements, usually by screwing. The fixing takes place on the sides of the housing to the body as well as on the front and back side of the housing to the body. Further fixings or screw connections are provided in the base plate and there preferably in correspondingly stable structures, in particular the seat cross members, on which the vehicle seats are mounted in the vehicle interior.

For fixing or screwing, corresponding fastening receptacles are provided on the housing at multiple specific fastening positions for fastening elements to be connected to the body or a body component such as a cross member, in particular a seat cross member, thus for example corresponding screws. These fastening receptacles are provided at defined fastening positions, which in turn correspond to specified fastening positions on the body side. In the case of fixing the energy storage to a transverse structure such as a cross member, which connection the invention is aimed at, the fastening positions are positioned on the storage housing in accordance with the distance between the cross members, viewed in the longitudinal direction of the vehicle. If two screw connections are provided on the transverse structures, i.e. on the cross members or seat cross members, then the fastening receptacles are positioned on the energy storage or the storage housing at the same distance that the two seat cross members have from one another. This allows the energy storage to be easily fixed, namely by screwing, on the floor or to the seat cross members, due to the corresponding fastening positions.

The housing is designed with respect to a specific body type or a specific wheelbase, so that the mounting positions correspond. If such an energy storage is to be installed on a different type of body with a longer wheelbase, the mounting position of the energy storage usually changes due to the longer wheelbase and the resulting slightly longer body, so that the fastening receptacles are no longer arranged congruently with the corresponding connection receptacles on the seat cross members. For this reason, the body must be locally stiffened by additional components in the area of the base plate, which in turn leads to a change in the design of additional components in the area of the base plate to meet the requirements with regard to a side crash and the like. Alternatively, the battery housing can be adjusted accordingly and the screwing positions can be offset accordingly.

### SUMMARY

The object of the invention is to specify an improved energy storage that is suitable for mounting on different body variants.

To achieve this object, in an energy storage of the type mentioned at the outset, it is provided according to the invention that a first fastening receptacle and a second fastening receptacle positioned offset from the first are provided at, at least some of, the fastening positions, wherein the two fastening receptacles in the fastening positions are provided offset in a common direction.

In the energy storage according to the invention, at least two separate fastening receptacles are provided for each fastening position at which a connection to the base plate or a cross member occurs, thus a vertical connection is provided. The two fastening receptacles are arranged offset from one another in a defined direction, wherein the two fastening receptacles of all of these fastening positions are offset in a common direction, for example the longitudinal direction of the generally rectangular energy storage. The fastening receptacles have an offset, wherein the specific offset ultimately is tailored to the different body shape on which the energy storage should be installed, or is adapted to the modified wheelbase. These two different fastening points per fastening position ensure that the energy storage can be installed on at least two different body types or two bodies with different wheelbases without additional effort. On the first body type, the screwing takes place via the first fastening receptacles, while on the longer second body type, for example, via the second fastening receptacles. This makes it possible, on the one hand, to be able to easily mount the energy storage on different body types or bodies with different wheelbases, and on the other hand, to always be able to attach or connect it to a correspondingly rigid structure such as the seat cross member, without requiring a different design of the body or also of the energy storage.

The fastening receptacles are expediently offset in a longitudinal direction of the housing, which is often of a rectangular basic shape, which may possibly differ therefrom in the front region due to electronic components or crash zones or the like integrated therein. The energy storage usually has a rectangular shape and is mounted with its longitudinal direction parallel to the longitudinal direction of the vehicle. The two fastening receptacles of each double fastening position are accordingly offset in the longitudinal direction of the vehicle, since with a longer wheelbase the body is inevitably slightly longer in the longitudinal direction of the vehicle.

The housing itself can expediently be designed as a frame, comprising a plurality of frame supports which run at right angles to one another, wherein the fastening receptacles are provided on at least some of the frame supports. The frame has a corresponding number of longitudinal and/or cross members, wherein it can also be divided via the various supports into multiple individual compartments in which the storage modules are accommodated. For vertical screwing, the corresponding fastening receptacles are provided on such longitudinal and/or cross members.

The fastening receptacles are preferably provided on frame supports extending in the longitudinal direction, i.e. on longitudinal members. Because these necessarily extend in the longitudinal direction of the vehicle, in which direction the body length varies with different wheelbases, so that the corresponding doubled fastening receptacles can be easily provided for each fastening position on the frame. Alternatively, the fastening receptacles can be provided on frame supports extending in the transverse direction if different vehicle widths are to be taken into account.

The first and/or the second fastening receptacles are preferably closed with releasable closing elements. The respectively required fastening receptacles are only opened by removing the closing elements when assembly is to take place. Such closing elements can, for example, be screwed-in plugs or similar. There are basically conceivable variants here. In a first variant, a thread can be provided in the battery housing, for screwing into the housing from above through the body. In a second variant, a threaded sleeve can be provided in the housing. Here screwing takes place into the body from below through the sleeve, wherein a thread, for example in the form of a threaded nut or similar, is provided in the body.

Each fastening receptacle is therefore expediently a threaded receptacle that serves to receive a fastening screw. This means that the vertical connection is made by screws, wherein the screws extend from the housing of the energy storage into the cross member.

In addition to the energy storage itself, the invention also relates to a motor vehicle, comprising a body as well as an energy storage of the type described above.

The body expediently has multiple cross members, in particular seat cross members, usually at least two, but possibly more, to which the fastening elements via which the energy storage is attached to the body side are fixed.

### BRIEF DESCRIPTION OF THE FIGURES

Further advantages and details of the invention follow from the exemplary embodiments described below and from the drawings. In particular:

FIG. 1 shows a schematic representation in the form of a top view of an energy storage according to the invention,

FIG. 2 shows a schematic representation of a partial view of a motor vehicle according to the invention with an energy storage mounted in a first position, and

FIG. 3 shows the arrangement from FIG. 2 with an energy storage arranged on a longer body in a second position.

### DETAILED DESCRIPTION

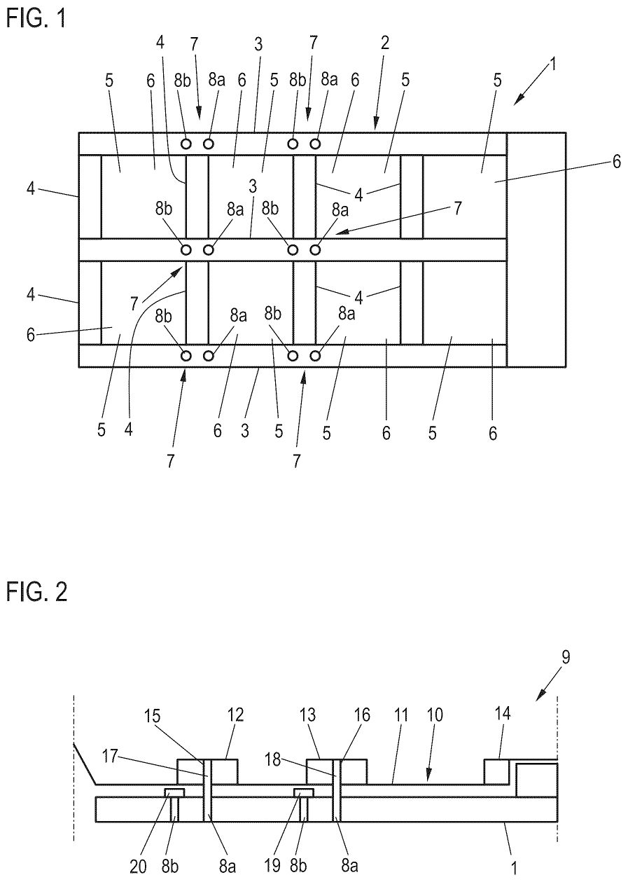

FIG. 1 shows an energy storage 1 according to the invention for a motor vehicle. The energy storage 1 comprises a housing 2, in the example shown consisting of multiple longitudinal members 3 and multiple cross members 4, via which the frame-like housing 2 is divided into several individual compartments 5, in each of which one or more storage modules 6 are accommodated and fixed. The longitudinal members are corresponding metal components. The basic structure of such an energy storage 1 is known.

For connecting or screwing the energy storage 1 below a base plate or underbody of a body of a motor vehicle, in the example shown, specified fastening positions 7 are defined on the three longitudinal members 3, on which in the example shown two respective fastening receptacles, namely a first fastening receptacle 8a and a second fastening receptacle 8b are provided. The two fastening receptacles 8a, 8b are arranged offset from one another in the longitudinal direction of the longitudinal members 3 by a defined distance. Each of the fastening receptacles 8a, 8b is used for screwing to the base plate, namely to correspondingly stable structures such as the seat cross members of the body. The arrangement of two fastening receptacles 8a, 8b that are offset from one another in a defined manner per fastening position 7 makes it possible to screw the energy storage 1 to the body side in different positions, in each case in such a stable structure or seat cross member. If the battery housing is fastened to the edge of a sill or close to the sill, i.e. outside of the base plate, it is sometimes possible, even with a wheelbase extension, for the attachment positions to be maintained, so that in such a case there are no multiple fastening receptacles 8a, 8b on the outer longitudinal members 3 to be provided, but only on the central longitudinal member 3, or on these, if multiple longitudinal members 3 arranged between the side longitudinal members 3 are provided.

FIG. 2 shows a partial view of a motor vehicle 9 according to the invention, comprising a body 10 with a base plate 11 or an underbody on which two seat cross members 12, 13 are provided as stable structures, as well as, for example, a heel plate 14. The two seat cross members 12, 13 have corresponding threaded holes or other openings 15, 16, which serve to accommodate a corresponding fastening element 17, 18, here suitable connecting screws.

The energy storage 1 is positioned beneath the base plate 11. The fastening elements 17, 18 are screwed into the respective first fastening receptacles 8a of the energy storage 1, as shown in FIG. 2. The fastening receptacles 8b are unoccupied here; as shown in FIG. 2, they are positioned offset in the longitudinal direction of the vehicle relative to the seat cross member 12, 13 or the respective openings 15, 16. They are closed by means of suitable closing elements 19, 20 such as suitable sealing plugs or the like.

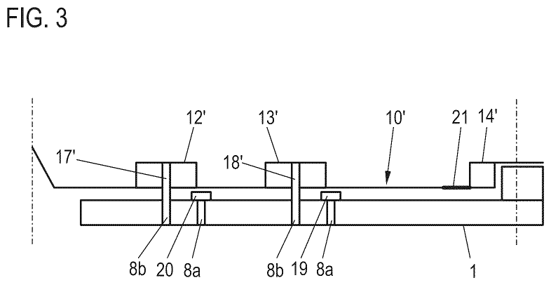

FIG. 3 shows the situation in which the same energy storage 1 is mounted on another, longer body 10′. The body 10′ has an extension portion 21, as shown in FIG. 3, through which the body 10′ is extended and a correspondingly longer wheelbase is created, as shown by the distance of the heel plate 14 with respect to the seat cross member 13′. The arrangement or the distance between the two seat cross members 12′, 13′ is the same as in the embodiment according to FIG. 2, while the body 10′ is longer.

The extension of the body 10′ now leads to the energy storage 1, which has a shape compatible with the underside of the base plate 11, as the figures show, being offset axially by a certain amount, namely the length of the extension portion 21, to the seat cross member 12′, 13 ‘. This now means that the fastening elements 17’, 18′ are not screwed into the fastening receptacles 8a, as in the example according to FIG. 2, but into the fastening receptacles 8b, which are exactly offset by the distance amount corresponding to the length of the extension portion 21, as FIG. 3 clearly shows. In this case, the fastening receptacles 8b are closed via the closing elements 19, 20. The same energy storage 1 can now be mounted, due to the arrangement of the at least two separate fastening receptacles 8a, 8b per fastening position 7, the distance between which corresponds to the length of the extension portion 21, i.e. the length by which the body and thus the wheelbase is longer than with a shorter body shape, on different body shapes or different wheelbases.

1. An energy storage for a motor vehicle, comprising a housing on which multiple fastening positions are formed, at which a fastening receptacle for a fastening element to be connected to a body component is provided, wherein
a first fastening receptacle and a second fastening receptacle positioned offset from the first are provided on at least some of the fastening positions, wherein the two fastening receptacles of the fastening positions are provided offset in a common direction.

2. The energy storage according to claim 1, wherein the fastening receptacles are offset in a longitudinal direction and/or in a transverse direction of the housing, which has a rectangular shape.

3. The energy storage according to claim 1, wherein the housing is designed as a frame, comprising multiple frame supports which run at right angles to one another, wherein the fastening receptacles are provided on at least some of the frame supports.

4. The energy storage according to claim 2, wherein the fastening receptacles are provided on frame supports extending in the longitudinal direction and/or in the transverse direction.

5. The energy storage according to claim 1, wherein the first and/or the second fastening receptacles are closed with releasable closing elements.

6. The energy storage according to claim 1, wherein each fastening receptacle is a threaded receptacle for receiving a fastening screw.

7. A motor vehicle, comprising a body and at least one energy storage according to claim 1.

8. The motor vehicle according to claim 7, wherein the body has multiple cross members, in particular seat cross members, to which the fastening elements are fixed, via which the energy storage is fastened on the body side.

9. The energy storage according to claim 2, wherein the housing is designed as a frame, comprising multiple frame supports which run at right angles to one another, wherein the fastening receptacles are provided on at least some of the frame supports.

10. The energy storage according to claim 3, wherein the fastening receptacles are provided on frame supports extending in the longitudinal direction and/or in the transverse direction.

11. The energy storage according to claim 2, wherein the first and/or the second fastening receptacles are closed with releasable closing elements.

12. The energy storage according to claim 3, wherein the first and/or the second fastening receptacles are closed with releasable closing elements.

13. The energy storage according to claim 4, wherein the first and/or the second fastening receptacles are closed with releasable closing elements.

14. The energy storage according to claim 2, wherein each fastening receptacle is a threaded receptacle for receiving a fastening screw.

15. The energy storage according to claim 3, wherein each fastening receptacle is a threaded receptacle for receiving a fastening screw.

16. The energy storage according to claim 4, wherein each fastening receptacle is a threaded receptacle for receiving a fastening screw.

17. The energy storage according to claim 5, wherein each fastening receptacle is a threaded receptacle for receiving a fastening screw.
